(19) United States
(12) Patent Application Publication
(10) Pub. No.: US 2026/0070348 A1
(43) Pub. Date: Mar. 12, 2026

(54) PRINTING SYSTEM

(71) Applicant: SEIKO EPSON CORPORATION, Tokyo (JP)

(72) Inventors: Hidekazu MORI, SHIOJIRI-SHI (JP); Jun FUJIMAKI, MATSUMOTO-SHI (JP); Yusuke WATANABE, AZUMINO-SHI (JP)

(21) Appl. No.: 19/318,952

(22) Filed: Sep. 4, 2025

(30) Foreign Application Priority Data
Sep. 6, 2024 (JP) 2024-154161

(51) Int. Cl. B41J 11/00; B05B 7/14; B41J 2/005; B41J 2/01; B41J 2/175

(52) U.S. Cl. CPC B41J 11/0015; B05B 7/14; B41J 2/0057; B41J 2/175; B41J 2002/012

(57) ABSTRACT

In a printing system including a printing apparatus that performs printing by ejecting liquid onto a transfer sheet and a powder spraying apparatus that sprays a hot-melt resin powder onto the transfer sheet, the printing apparatus includes a medium supply unit that holds the transfer sheet wound in a roll shape and a liquid ejection unit that ejects the liquid, the powder spraying apparatus includes a powder housing unit that houses the hot-melt resin powder having a particle diameter of 10 μm or more and 350 μm or less and a powder spraying unit that sprays the hot-melt resin powder onto the transfer sheet onto which the liquid has been ejected, and a first space in which the transfer sheet wound in a roll shape with respect to the medium supply unit can be replaced is secured between the printing apparatus and the powder spraying apparatus.

The present application is based on, and claims priority from JP Application Serial Number 2024-154161, filed Sep. 6, 2024, the disclosure of which is hereby incorporated by reference herein in its entirety.

### BACKGROUND

### 1. Technical Field

The present disclosure relates to a printing system.

### 2. Related Art

Conventionally, various printing systems have been used. Among these systems, there is a printing system including a printing apparatus that performs printing by ejecting liquid onto a transfer sheet, and a powder spraying apparatus that sprays hot-melt resin powder onto the transfer sheet on which printing has been performed by the printing apparatus. For example, JP-A-2022-147673 discloses a thermal transfer material manufacturing apparatus for a strip-shaped base material including an ink image layer forming unit that performs printing on the strip-shaped base material by inkjet printing and a hot-melt resin powder layer forming unit that sprays hot-melt resin powder on the strip-shaped base material on which printing has been performed by the ink image layer forming unit.

JP-A-2022-147673 is an example of the related art.

However, in an existing printing system including a printing apparatus and a powder spraying apparatus, such as the thermal transfer material manufacturing apparatus for a strip-shaped base material disclosed in JP-A-2022-147673, in some cases, workability in performing various types of work such as replenishment of a hot-melt resin powder and replacement of a transfer sheet is poor. This is because, when the printing system is disposed in a narrow space, a large work space has to be taken around each of the printing apparatus and the powder spraying apparatus, and thus the printing apparatus and the powder spraying apparatus have to be disposed close to each other. When the printing apparatus and the powder spraying apparatus are disposed close to each other, the hot-melt resin powder may reach the printing apparatus due to replenishment of the hot-melt resin powder in the powder spraying apparatus.

### SUMMARY

In order to solve the above-described problems, a printing system of the present disclosure is a printing system including: a printing apparatus that performs printing by ejecting liquid onto a transfer sheet; and a powder spraying apparatus that sprays a hot-melt resin powder onto the transfer sheet, in which the printing apparatus includes a medium supply unit that holds the transfer sheet wound in a roll shape, and a liquid ejection unit that ejects the liquid onto the transfer sheet supplied from the medium supply unit, the powder spraying apparatus includes a powder housing unit that houses the hot-melt resin powder having a particle diameter of 10 μm or more and 350 μm or less, and a powder spraying unit that sprays the hot-melt resin powder supplied from the powder housing unit onto the transfer sheet onto which the liquid has been ejected, the printing apparatus and the powder spraying apparatus are installed with a first space secured between the printing apparatus and the powder spraying apparatus, and the printing apparatus is configured to be able to replace the transfer sheet wound in a roll shape with respect to the medium supply unit in the first space.

### BRIEF DESCRIPTION OF THE DRAWINGS

FIG. 1 is a schematic view of a printing system according to an example 1 of the present disclosure.

FIG. 2 is a schematic perspective view of a printing apparatus of the printing system of FIG. 1.

FIG. 3 is a perspective view illustrating the periphery of an opening/closing cover of the printing apparatus of FIG. 2.

FIG. 4 is a schematic view illustrating an arrangement example of the printing system of FIG. 1.

FIG. 5 is a bottom view of a head provided in the printing apparatus of the printing system of FIG. 1.

FIG. 6 is a schematic view of a printing system according to an example 2 of the present disclosure.

FIG. 7 is a schematic view illustrating an arrangement example of a printing system of a reference example.

### DESCRIPTION OF EMBODIMENTS

First, the present disclosure will schematically be described.

In order to solve the above problems, a system according to a first aspect of the present disclosure is a printing system including: a printing apparatus that performs printing by ejecting liquid onto a transfer sheet; and a powder spraying apparatus that sprays a hot-melt resin powder onto the transfer sheet, in which the printing apparatus includes a medium supply unit that holds the transfer sheet wound in a roll shape, and a liquid ejection unit that ejects the liquid onto the transfer sheet supplied from the medium supply unit, the powder spraying apparatus includes a powder housing unit that houses the hot-melt resin powder having a particle diameter of 10 μm or more and 350 μm or less, and a powder spraying unit that sprays the hot-melt resin powder supplied from the powder housing unit onto the transfer sheet onto which the liquid has been ejected, the printing apparatus and the powder spraying apparatus are installed with a first space secured between the printing apparatus and the powder spraying apparatus, and the printing apparatus is configured to be able to replace the transfer sheet wound in a roll shape with respect to the medium supply unit in the first space.

According to the present aspect, since the printing apparatus and the powder spraying apparatus are installed with the first space secured and the transfer sheet can be replaced in the first space, it is possible to replace the transfer sheet without taking a large work space around the printing system. In addition, since the printing apparatus and the powder spraying apparatus are installed with the first space secured, and the hot-melt resin powder having a particle diameter of 10 μm or more and 350 μm or less is used, in a state where the first space is secured, it is possible to suppress the scattering of the hot-melt resin powder from the powder spraying apparatus to the printing apparatus, and it is possible to suppress a problem in the printing apparatus due to leakage of the hot-melt resin powder.

The printing system according to a second aspect of the present disclosure is the printing system according to the first aspect, in which the medium supply unit is located above the liquid ejection unit.

According to the present aspect, the medium supply unit is located above the liquid ejection unit. With such a configuration, the transfer sheet can be easily replaced not only when the work is performed from the first space side but also when the work is performed from the side opposite to the first space side.

The printing system according to a third aspect of the present disclosure is the printing system according to the first aspect, in which the medium supply unit is located below the liquid ejection unit.

According to the present aspect, the medium supply unit is located below the liquid ejection unit. With such a configuration, the transfer sheet can be easily replaced by performing work from the first space side.

The printing system according to a fourth aspect of the present disclosure is the printing system according to the first aspect, the printing system includes a liquid supply unit that holds the liquid to be supplied to the liquid ejection unit, in which the liquid supply unit is configured to be capable of replacing the liquid or replenishing the liquid in the first space.

According to the present aspect, the liquid supply unit is configured to be capable of replacing the liquid or replenishing the liquid in the first space. With such a configuration, it is also possible to perform work in the first space with respect to the replacement of the liquid or the replenishment of the liquid, and it is possible to reduce the work space on the side opposite to the first space side of the printing apparatus.

The printing system according to a fifth aspect of the present disclosure is the printing system according to the fourth aspect, in which the liquid supply unit is located below the liquid ejection unit, and the transfer sheet onto which the liquid has been ejected is transported above the liquid supply unit and sent to the powder spraying apparatus.

According to the present aspect, the liquid supply unit is located below the liquid ejection unit, and the transfer sheet onto which the liquid has been ejected is transported above the liquid supply unit and sent to the powder spraying apparatus. With such a configuration, the printing apparatus can be downsized in the horizontal direction, and the space of the printing system can be further saved.

The printing system according to a sixth aspect of the present disclosure is the printing system according to the first aspect, in which the hot-melt resin powder has an average particle diameter of 100 μm or more and 200 μm or less.

According to the present aspect, the average particle diameter of the hot-melt resin powder is 100 μm or more and 200 μm or less. By using such a hot-melt resin powder, in a state where the first space is secured, it is possible to particularly effectively suppress the scattering of the hot-melt resin powder from the powder spraying apparatus to the printing apparatus, and it is possible to particularly effectively suppress a problem in the printing apparatus due to leakage of the hot-melt resin powder.

### EXAMPLE 1

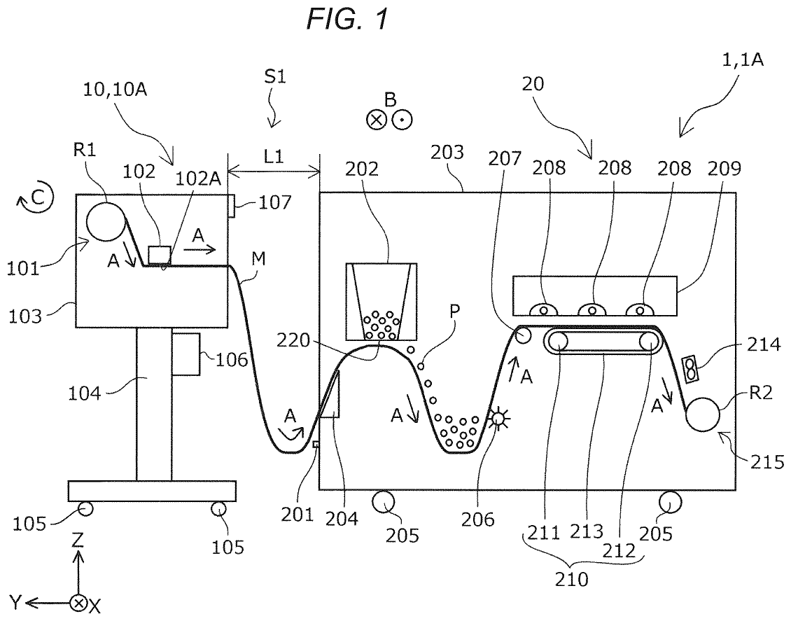

Hereinafter, embodiments according to the present disclosure will be specifically described with reference to the drawings. First, an outline of a printing system 1A of a first example, which is an example of a printing system 1 of the present disclosure, will be described with reference to FIGS. 1 to 3. In FIG. 1, some component members are simplified and omitted for easy understanding of the configuration. Here, in each drawing, an X-axis direction in the drawing is a horizontal direction and is an axial direction of a roll body R1 in which a transfer sheet M as a medium is wound in a roll shape, a Y-axis direction is a horizontal direction, is a front-rear direction of the printing system 1A, and is a direction orthogonal to the X-axis direction, and a Z-axis direction is a vertical direction. In the following description, a direction in which an arrow is directed is defined as a + direction, and a direction opposite to the direction in which the arrow is directed is defined as a − direction. For example, the vertically upward direction is defined as the +Z direction, the vertically downward direction is defined as the −Z direction, the front surface direction of the printing system 1A is defined as the −Y direction, and the back surface direction of the printing system 1A is defined as the +Y direction.

As illustrated in FIG. 1, the printing system 1A of the present example is the printing system 1 including a printing apparatus 10 that performs printing by ejecting ink, which is liquid, onto the transfer sheet M, and a powder spraying apparatus 20 that sprays a hot-melt resin powder P onto the transfer sheet M. First, an outline of a printing apparatus 10A of the present example as the printing apparatus 10 provided in the printing system 1A will be described with reference to FIGS. 1 to 3.

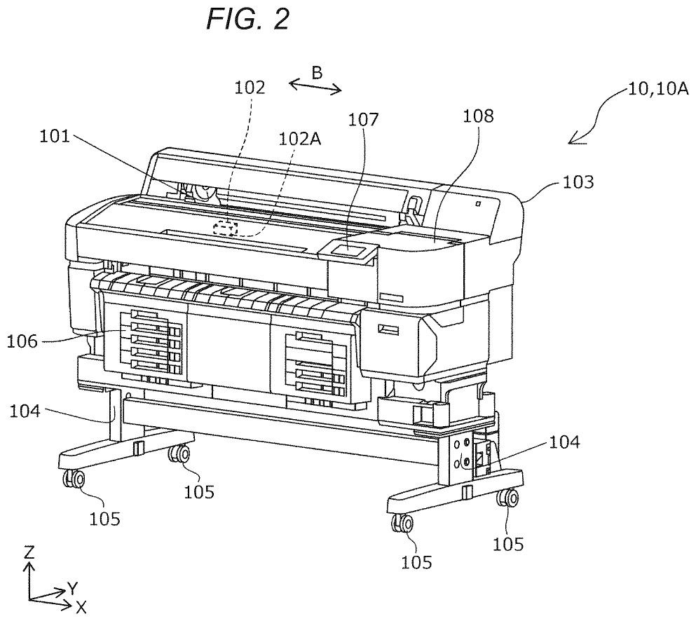

As illustrated in FIGS. 1 and 2, the printing apparatus 10A of the present example includes a housing 103, and leg frames 104 are attached to portions near both ends of the housing 103 in the X-axis direction. A caster 105 is provided below the leg frame 104, and the printing apparatus 10A can be easily moved using the caster 105.

In addition, the printing apparatus 10A according to the present example includes a medium supply unit 101 that holds the roll body R1 at an upper position inside the housing 103. The medium supply unit 101 supports the roll body R1 around which the transfer sheet M is wound, and supplies the transfer sheet M to a position facing an ink ejection surface 102A of a head 102 as a liquid ejection unit.

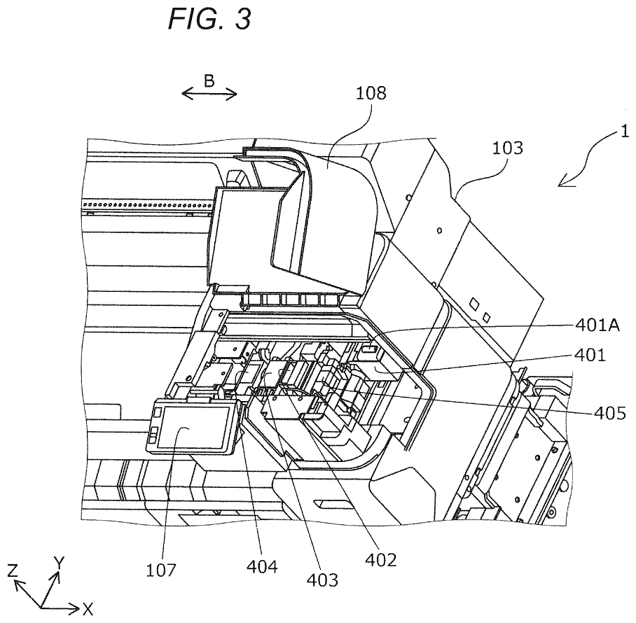

In addition, the housing 103 is provided with an operation panel 107. An opening/closing cover 108 is provided at a position of an end portion of the housing 103 on the +X direction side and the −Y direction side. The inside of the opening/closing cover 108 is a standby position of the head 102 in a state of not performing printing, that is, a so-called home position of the head 102, and as illustrated in FIG. 3, a cap 404 that covers a nozzle of the ink ejection surface 102A is provided at a position facing the ink ejection surface 102A when the head 102 is at the home position. The detailed configuration of the head 102 will be described later. A flushing box 403 for flushing is provided at a position adjacent to the cap 404 on the +X direction side, and a suction cap 402 for sucking the nozzle of the ink ejection surface 102A is provided at a position adjacent to the flushing box 403 on the +X direction side. Furthermore, a degassing unit 405 that removes bubbles in the ink is provided at a position adjacent to the suction cap 402 on the +X direction side.

Then, a cloth wiper 401 capable of wiping the ink ejection surface 102A is provided on the +X direction side of the degassing unit 405. The cloth wiper 401 is movable along the Y-axis direction, and wipes the ink ejection surface 102A with a roll 401A of cloth wound in a roll shape while moving along the Y-axis direction. Note that, the home position of the cloth wiper 401 is on the +Y direction side of the movement range of the head 102, and when the opening/closing cover 108 is opened when the head 102 moves to the +X direction side at the maximum, the ink ejection surface 102A can be visually confirmed from the lower side via a space formed by the movement of the cloth wiper 401 to the +Y direction side, and work such as cleaning the ink ejection surface 102A with a cotton swab or the like can be performed. In order to facilitate such work, the opening/closing cover 108 is configured to be opened to a deep position in the −Z direction.

That is, the inside of the opening/closing cover 108 is a home position of the head 102 and a maintenance position for performing maintenance of the head 102. From another viewpoint, the opening/closing cover 108 of the present example is a maintenance cover that can be opened and closed when an operator performs maintenance of the head 102. In addition, by opening the opening/closing cover 108, the cloth wiper 401, the suction cap 402, the flushing box 403, the cap 404, the degassing unit 405, and the like as the maintenance units can be replaced and cleaned. Note that, such maintenance operation can be performed in a first space S1 to be described later.

In the printing apparatus 10A of the present example, when the transfer sheet M is transported in a transport direction A, the roll body R1 supported by the medium supply unit 101 rotates in a rotation direction C. Note that, in FIG. 1, the roll body R1 wound such that an image forming surface on which an image is formed is on the outer side is used, but when the roll body R1 wound such that the image forming surface is on the inner side is used, the medium supply unit 101 can feed the transfer sheet M by rotating the roll body R1 in a direction opposite to the rotation direction C.

In addition, the printing apparatus 10A of the present example includes a transport path of the transfer sheet M including a platen (not illustrated) that supports the transfer sheet M on a support surface or the like. In addition, the printing apparatus 10A includes a pair of transport rollers (not illustrated) as a transport unit for transporting the transfer sheet M in the transport direction A in the transport path. However, the configuration of the transport unit is not particularly limited.

In addition, the printing apparatus 10A of the present example includes the head 102 as a liquid ejection unit that is provided with a plurality of nozzles and ejects ink, which is liquid, from the nozzles to form an image, and a carriage on which the head 102 is mounted and which can reciprocate in a width direction B. That is, the width direction B corresponds to the scanning direction of the carriage.

A liquid supply path (not illustrated) formed of a tube or the like is coupled to the head 102, and ink is supplied from an ink cartridge mounting portion 106 as a liquid supply unit to the head 102 via the liquid supply path. Note that, in the printing apparatus 10A of the present example, the transport direction A at a position facing the ink ejection surface 102A of the head 102 is the −Y direction, the movement direction of the head 102, that is, the width direction B which is the scanning direction of the carriage is a direction along the X-axis direction, and the ink ejection direction is the −Z direction.

With the above configuration, the head 102 can form an image by ejecting ink from the nozzles onto the transported transfer sheet M while reciprocating in the width direction B, which is a direction intersecting the transport direction A. The printing apparatus 10A of the present example can form a desired image on the transfer sheet M by repeating transport of the transfer sheet M in the transport direction A by a predetermined transport amount and ejection of ink while moving the head 102 in the width direction B in a state where the transfer sheet M is stopped. However, the present disclosure is not limited to such a configuration, and may be a configuration including a so-called line head in which nozzles that eject ink along the width direction B are arranged over the entire width of the transfer sheet M.

The transfer sheet M on which printing has been performed by the head 102 is discharged from the printing apparatus 10A and sent to the powder spraying apparatus 20. Here, in the printing system 1A of the present example, the printing apparatus 10A and the powder spraying apparatus 20 are disposed at an interval of a length L1 in the Y-axis direction. Next, the powder spraying apparatus 20 of the present example will be described with reference to FIG. 1.

The powder spraying apparatus 20 of the present example includes a housing 203, and casters 205 are provided below the housing 203. The powder spraying apparatus 20 can be easily moved using the casters 205. The powder spraying apparatus 20 includes a sensor 201 that detects the transfer sheet M outside the housing 203. The transfer sheet M transported from the printing apparatus 10A to the powder spraying apparatus 20 is transported in a state of hanging down as illustrated in FIG. 1, from the printing apparatus 10A to the powder spraying apparatus 20. The sensor 201 detects the transfer sheet M in a state of hanging down from the printing apparatus 10A to the powder spraying apparatus 20. The powder spraying apparatus 20 may include a placement table on which the transfer sheet M transported from the printing apparatus 10A to the powder spraying apparatus 20 is placed in a transportable state. The placement table may have a flat surface and support the transfer sheet M discharged from the printing apparatus 10A on the flat surface so as not to hang down. The placement table may be configured to be capable of changing an angle at which the placement table protrudes toward the printing apparatus 10A.

In addition, the powder spraying apparatus 20 includes a heater 204 for heating the transfer sheet M onto which the ink has been ejected in the printing apparatus 10A, inside the housing 203 and downstream of the sensor 201 in the transport direction A. The heater 204 of the present example is a heater that heats the transfer sheet M from the side opposite to the image forming surface of the transfer sheet M, but the configuration of the heater is not particularly limited. For example, an infrared heater may be used. Note that, when the powder spraying apparatus 20 includes the placement table that supports the transfer sheet M so as not to hang down, the placement table may include the heater for heating the transfer sheet M.

In addition, the powder spraying apparatus 20 includes, downstream of the heater 204 in the transport direction A, a powder housing unit 202 that houses the hot-melt resin powder P, and a powder spraying unit 220 that sprays the hot-melt resin powder P supplied from the powder housing unit 202 onto the transfer sheet M. In the powder spraying apparatus 20 of the present example, the hot-melt resin powder P having a particle diameter of 10 μm or more and 350 μm or less is used. The hot-melt resin powder P is sprayed onto the image forming surface of the transfer sheet M by the powder spraying unit 220. In the powder spraying unit 220, the hot-melt resin powder P is sprayed over the entire width of the transfer sheet M. The hot-melt resin powder P is preferably sprayed in a state where the ink ejected onto the image forming surface of the transfer sheet M is not dried. By spraying the hot-melt resin powder P in a wet state, the hot-melt resin powder P can be attached only to a wet portion.

In addition, the powder spraying apparatus 20 is provided with a brush roller 206 downstream of the powder spraying unit 220 in the transport direction A. The brush roller 206 rotates while being in contact with the surface of the transfer sheet M opposite to the image forming surface. The brush roller 206 is configured to strike and come into contact with the surface of the transfer sheet M opposite to the image forming surface to apply vibration to the transfer sheet M and remove the hot-melt resin powder P excessively adhering to the image forming surface of the transfer sheet M.

In addition, the powder spraying apparatus 20 is provided with a pickup roller 207 and a transport unit 210 downstream of the brush roller 206 in the transport direction A. The transport unit 210 includes a drive roller 211, a driven roller 212, and an endless belt 213, and the endless belt 213 is stretched between the drive roller 211 and the driven roller 212. When the drive roller 211 rotates in the rotation direction C by a driving force of a motor (not illustrated), the driven roller 212 also rotates in the rotation direction C via the endless belt 213.

A heating unit 209 having a plurality of infrared heaters 208 is provided at a position facing the pickup roller 207 and the transport unit 210. The image forming surface of the transfer sheet M on which the hot-melt resin powder P has been sprayed is heated by the heating unit 209 to fix the hot-melt resin powder P on the image forming surface of the transfer sheet M.

In addition, the powder spraying apparatus 20 is provided with an air blowing unit 214 downstream of the heating unit 209 in the transport direction A. By cooling the image forming surface of the transfer sheet M on which the hot-melt resin powder P has been sprayed by the air blowing via the air blowing unit 214, the hot-melt resin powder P is solidified. Thus, a resin layer is formed on the image forming surface of the transfer sheet M.

In addition, the powder spraying apparatus 20 is provided with a winding unit 215 capable of winding the transfer sheet M in a roll shape downstream of the air blowing unit 214 in the transport direction A. A roll body R2 is formed by the winding unit 215 winding the transfer sheet M on which the resin layer has been formed on the image forming surface.

As described above, the printing system 1A of the present example includes the printing apparatus 10A including the medium supply unit 101 that holds the transfer sheet M wound in a roll shape and the head 102 that ejects ink onto the transfer sheet M supplied from the medium supply unit 101. The printing system 1A also includes the powder spraying apparatus 20 including the powder housing unit 202 that houses the hot-melt resin powder P having a particle diameter of 10 μm or more and 350 μm or less, and the powder spraying unit 220 that sprays the hot-melt resin powder P supplied from the powder housing unit 202 onto the transfer sheet M onto which the ink has been ejected. Here, the arrangement of the printing apparatus 10A and the powder spraying apparatus 20 in the printing system 1A of the present example will be described.

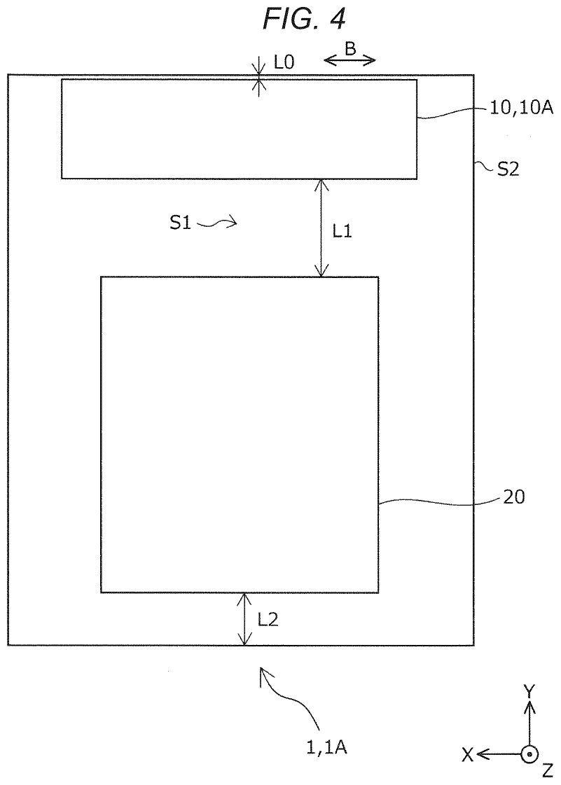

As described above, in the printing system 1A of the present example, the printing apparatus 10A and the powder spraying apparatus 20 are disposed at an interval of the length L1 in the Y-axis direction. In other words, as illustrated in FIGS. 1 and 4, in the printing system 1A of the present example, the printing apparatus 10A and the powder spraying apparatus 20 are installed with the first space S1 secured between the printing apparatus 10A and the powder spraying apparatus 20. Then, since the printing apparatus 10A and the powder spraying apparatus 20 are disposed in this manner in the printing system 1A of the present example, the printing apparatus 10A of the present example can replace, in the first space S1, the transfer sheet M wound in a roll shape with respect to the medium supply unit 101, that is, the roll body R1. It is preferable that the first space S1 is large enough for the operator to perform various types of work.

FIG. 4 is an arrangement example of the printing apparatus 10A and the powder spraying apparatus 20 in the printing system 1A of the present example, but since the printing apparatus 10A and the powder spraying apparatus 20 are installed with the first space S1 secured and the transfer sheet M can be replaced in the first space S1, it is possible to replace the transfer sheet M without taking a large work space around the printing system 1. Specifically, an entire work space S2 of the printing system 1 can be reduced by shortening a length L0 required for the work space on the +Y direction side (the side opposite to the side on which the powder spraying apparatus 20 is disposed) of the printing apparatus 10A, for example, by making the length L0 substantially zero.

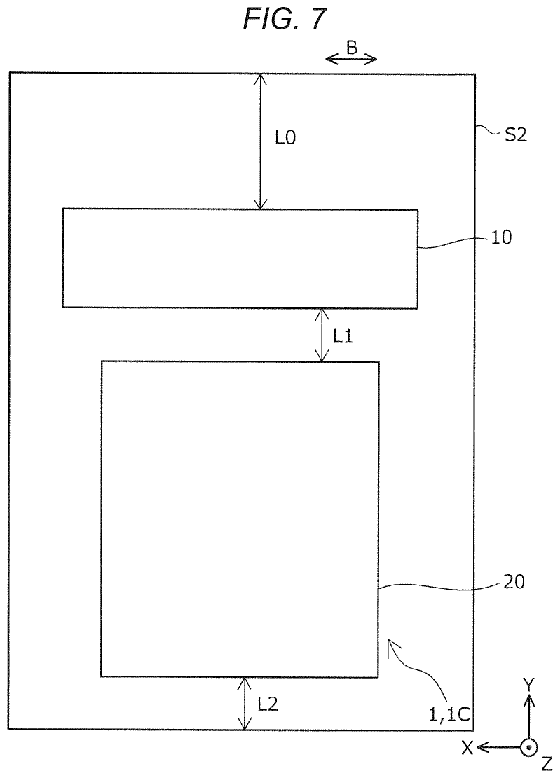

Here, a printing system 1C of a reference example in which the roll body R1 is not configured to be replaceable from the −Y direction side with respect to the printing apparatus 10 and the printing apparatus 10 and the powder spraying apparatus 20 are not installed with the first space S1 secured between the printing apparatus 10 and the powder spraying apparatus 20 will be considered. In FIG. 7 illustrating the arrangement example of the printing system 1C of the reference example, a length L2 required as the work space on the −Y direction side (side opposite to the side on which the printing apparatus 10 is disposed) of the powder spraying apparatus 20 is the same as that of the printing system 1A of the present example, and the length L1 can be slightly shorter than that of the printing system 1A of the present example, but the length L0 cannot be shortened. Therefore, as is clear from a comparison between FIG. 4 and FIG. 7, the printing system 1A of the present example can reduce the entire work space S2 of the printing system 1 as compared with the printing system 1C of the reference example.

Note that, in the printing system 1A of the present example illustrated in FIG. 4, the occupied area of the printing apparatus 10 in plain view is 1.2 m², the occupied area of the powder spraying apparatus 20 in plan view is 2.44 m², and the occupied area of the entire work space S2 of the printing system 1 in plan view is 7.68 m². Meanwhile, in the printing system 1C of the reference example illustrated in FIG. 7, the occupied area of the printing apparatus 10 in plan view is 1.38 m², the occupied area of the powder spraying apparatus 20 in plan view is 2.44 m², and the occupied area of the entire work space S2 of the printing system 1 in plan view is 12.39 m².

In addition, as in the printing system 1A of the present example, the printing apparatus 10 and the powder spraying apparatus 20 are installed with the first space S1 secured, and the hot-melt resin powder P having particle diameter of 10 μm or more and 350 μm or less is used, so that it is possible to suppress the scattering of the hot-melt resin powder P from the powder spraying apparatus 20 to the printing apparatus 10, and it is possible to suppress a problem in the printing apparatus 10 due to leakage of the hot-melt resin powder P. Note that when the first space S1 is secured, the length L1, which is an interval between the printing apparatus 10 and the powder spraying apparatus 20, is preferably 500 mm or more, for example. By setting the length L1 to 500 mm or more, various types of work in the first space S1 can be facilitated, and the adhesion of the hot-melt resin powder P scattered from the powder spraying apparatus 20 to the printing apparatus 10A can be particularly effectively suppressed. Furthermore, when necessary, a resin powder leakage prevention unit, for example, a curtain-shaped portion, an air curtain portion, or the like may be provided in the first space S1. Note that when the powder spraying apparatus 20 includes a placement table that supports the transfer sheet M so as not to hang down, the placement table is preferably configured to be foldable so as to secure the first space S1.

Note that, the average particle diameter of the hot-melt resin powder P used is more preferably 100 μm or more and 200 μm or less. This is because, by using such a hot-melt resin powder P, it is possible to particularly effectively suppress the scattering of the hot-melt resin powder P from the powder spraying apparatus 20 to the printing apparatus 10, and it is possible to particularly effectively suppress a problem in the printing apparatus 10 due to leakage of the hot-melt resin powder P.

In addition, as described above, in the printing system 1A of the present example, the printing apparatus 10A includes the ink cartridge mounting portion 106 as the liquid supply unit that holds the ink to be supplied to the head 102. Here, the ink cartridge mounting portion 106 is configured such that the ink cartridge can be replaced in the first space S1. As described above, the liquid supply unit is preferably configured to be capable of replacing the liquid (ink) or replenishing the liquid in the first space S1. This is because, with such a configuration, it is possible to perform work of the replacement of the liquid or the replenishment of the liquid in the first space S1, and it is possible to reduce the work space on the side opposite to the first space S1 side of the printing apparatus 10.

In addition, as illustrated in FIG. 1, in the printing system 1A of the present example, the operation panel 107 is provided on the −Y direction side (first space S1 side) of the housing 103 in the printing apparatus 10A. With such a configuration, according to various instructions to the printing apparatus 10A, work can be performed in the first space S1, and the work space on the side opposite to the first space S1 side of the printing apparatus 10 can be reduced.

In addition, as illustrated in FIG. 1, in the printing system 1A of the present example, the ink cartridge mounting portion 106 is located below the head 102, and the transfer sheet M onto which the ink has been ejected is transported above the ink cartridge mounting portion 106 and sent to the powder spraying apparatus 20. With such a configuration, the printing apparatus 10 can be downsized in the horizontal direction, and the space of the printing system 1 can be further saved. In addition, when the hot-melt resin powder P scatters between the printing apparatus 10A and the powder spraying apparatus 20, the transfer sheet M transported from the printing apparatus 10A to the powder spraying apparatus 20 can prevent the hot-melt resin powder P from reaching the ink cartridge mounting portion 106. Note that, in the printing system 1A of the example, the ink cartridge mounting portion 106 is located between the leg frames 104 provided in the vicinity of both ends of the housing 103 in the X-axis direction.

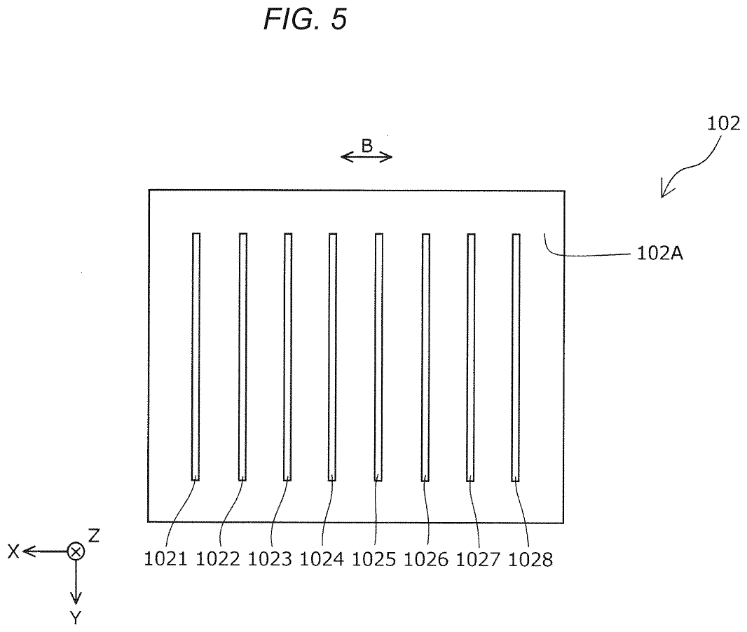

In addition, the printing apparatus 10A of the present example is configured such that a plurality of types of ink cartridges can be mounted in the ink cartridge mounting portion 106 and a plurality of types of ink can be ejected. As illustrated in FIG. 5, in the head 102 of the example, a plurality of nozzle rows 1021, 1022, 1023, 1024, 1025, 1026, 1027, and 1028 corresponding to the plurality of types of ink are provided on the ink ejection surface 102A.

Here, the printing apparatus 10A of the present example can eject white ink, yellow ink, magenta ink, cyan ink, and black ink. In this case, for example, the ink ejected from the nozzle rows 1021, 1022, 1027, and 1028 may be white ink, the ink ejected from the nozzle row 1023 may be cyan ink, the ink ejected from the nozzle row 1024 may be magenta ink, the ink ejected from the nozzle row 1025 may be yellow ink, and the ink ejected from the nozzle row 1026 may be black ink.

As described above, the white ink is preferably ejected from the nozzle rows at the end portion in the scanning direction of the carriage corresponding to the width direction B. This is because, by ejecting the white ink from the nozzle rows at the end portion in the scanning direction of the carriage corresponding to the width direction B, it is possible to make it difficult to affect the deterioration of the printed image.

In the printing apparatus 10 used together with the powder spraying apparatus 20 such as the printing apparatus 10A of the present example, as the maintenance mechanism of the head 102, the cloth wiper 401 having the cloth roll 401A, that is, the cloth wiper 401 that wipes by pressing the cloth with rollers supporting both ends is used. In the cloth wiper 401 having such a configuration, portions closer to both ends of the roller are strongly pressed against the ink ejection surface 102A, and the water-repellent film of the ink ejection surface 102A is scraped and easily scratched. When the ink ejection surface 102A is scratched in the vicinity of the nozzle, the ejection direction of the ink changes, and the landing position of the ink ejected onto the transfer sheet M may vary. In many cases, the white ink is used as an adhesive to attach the hot-melt resin powder P to the transfer sheet M, and the white ink has less adverse effects due to variations in landing positions of the ink as compared with other color inks for image formation. Therefore, the white ink is preferably ejected from the nozzle rows at the end portion in the scanning direction of the carriage corresponding to the width direction B.

In addition, in the printing system 1A of the present example, as illustrated in FIG. 1, the medium supply unit 101 is located above the head 102. From another viewpoint, in the printing system 1A of the present example, the medium supply unit 101 is located above the medium transport path. With such a configuration, it is possible to easily replace the roll body R1 of the transfer sheet M not only when the work is performed from the first space S1 side but also when the work is performed from the side opposite to the first space S1 side. In the printing system 1A of the present example, the medium supply unit 101 is located on the +Y direction side of the head 102 in plan view. The medium supply unit 101 is located on the most +Y direction side in the medium transport path. However, the present disclosure is not limited to such a configuration.

### EXAMPLE 2

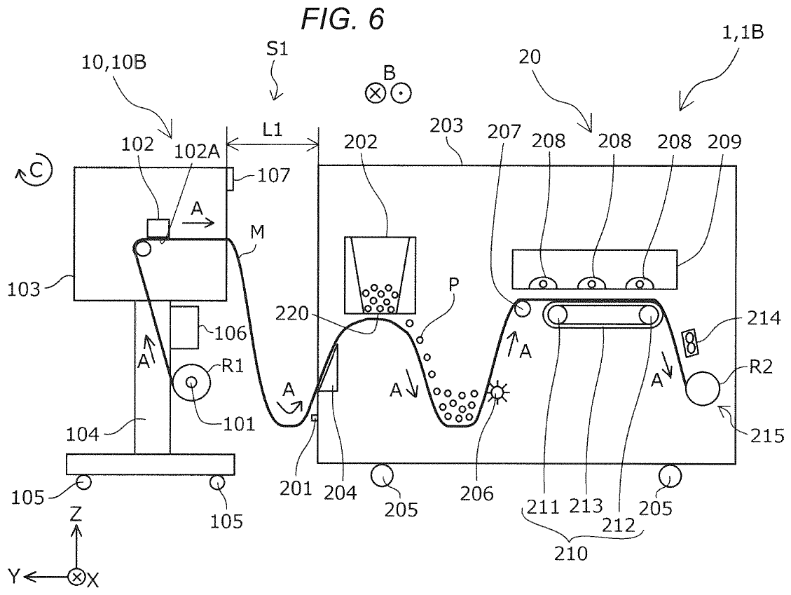

Next, a printing system 1B according to an example 2 will be described with reference to FIG. 6. In FIG. 6, the component members in common with the above described example 1 have the same reference signs and the detailed explanation thereof will be omitted. Note that, FIG. 6 is a view corresponding to FIG. 1 in the printing system 1A of the example 1. Here, the printing system 1B of the present example has the similar configuration to the printing system 1A of the example 1 except for the configuration of the printing apparatus 10 provided in the printing system 1. Therefore, the printing system 1B of the present example has the similar features to the printing system 1A of the example 1 except for the parts described below.

As described above, in the printing apparatus 10A of the printing system 1A of the example 1, the medium supply unit 101 is located above the head 102. However, as illustrated in FIG. 6, in a printing apparatus 10B of the printing system 1B of the present example, the medium supply unit 101 is located below the head 102. From another viewpoint, in the printing system 1B of the present example, the medium supply unit 101 is located below the medium transport path. In addition, in the printing apparatus 10B of the printing system 1B of the present example, the medium supply unit 101 may be located within a range in which the housing 103 is provided in plan view. The medium supply unit 101 may be located on the −Y direction side within the range in which the housing 103 is provided in plan view. With such a configuration, the roll body R1 of the transfer sheet M can be easily replaced by performing work from the first space S1 side. Furthermore, the medium supply unit 101 of the printing apparatus 10B is located on the −Y direction side of the position on the most +Y direction side in the medium transport path. Since the medium supply unit 101 of the printing apparatus 10B is located so as to overlap the medium transport path downstream of the medium supply unit 101 in plan view, the length of the printing apparatus 10B in the front-rear direction can be shortened. Note that it is preferable that the medium supply unit 101 of the printing apparatus 10B is located so as not to overlap the ink cartridge mounting portion 106 in the X-axis direction.

Note that, the printing apparatus 10B of the present example and the printing apparatus 10A of the example 1 include only one medium supply unit 101, but may include a plurality of medium supply units 101. By adopting a configuration having the plurality of medium supply units 101, it is possible to easily change and use the transfer sheets M of different sizes and types.

The present disclosure is not limited to the above-described examples and can be implemented in various configurations without departing from the gist of the present disclosure. In addition, in order to solve a part or all of the problems described above, or to achieve a part or all of the effects described above, the technical features in the examples corresponding to the technical features in the respective aspects described in SUMMARY can be replaced or combined as appropriate. In addition, the technical features can be deleted as appropriate unless described as essential features in the present specification.

What is claimed is:

1. A printing system comprising: a printing apparatus configured to perform printing by ejecting liquid onto a transfer sheet; and a powder spraying apparatus configured to spray a hot-melt resin powder onto the transfer sheet, wherein the printing apparatus includes a medium supply unit configured to hold the transfer sheet wound in a roll shape, and a liquid ejection unit configured to eject the liquid onto the transfer sheet supplied from the medium supply unit, the powder spraying apparatus includes a powder housing unit configured to house the hot-melt resin powder having a particle diameter of 10 μm or more and 350 μm or less, and a powder spraying unit configured to spray the hot-melt resin powder supplied from the powder housing unit onto the transfer sheet onto which the liquid has been ejected, the printing apparatus and the powder spraying apparatus are installed with a first space secured between the printing apparatus and the powder spraying apparatus, and
the printing apparatus is configured to be able to replace the transfer sheet wound in a roll shape with respect to the medium supply unit in the first space.

2. The printing system according to claim 1, wherein the medium supply unit is located above the liquid ejection unit.

3. The printing system according to claim 1, wherein the medium supply unit is located below the liquid ejection unit.

4. The printing system according to claim 1, further comprising a liquid supply unit that holds the liquid to be supplied to the liquid ejection unit,
wherein the liquid supply unit is configured to be capable of replacing the liquid or replenishing the liquid in the first space.

5. The printing system according to claim 4, wherein the liquid supply unit is located below the liquid ejection unit, and
the transfer sheet onto which the liquid has been ejected is transported above the liquid supply unit and sent to the powder spraying apparatus.

6. The printing system according to claim 1, wherein the hot-melt resin powder has an average particle diameter of 100 μm or more and 200 μm or less.
